(19) United States
(12) Patent Application Publication
(10) Pub. No.: US 2017/0249680 A1
(43) Pub. Date: Aug. 31, 2017

(54) System and Method for Creating an Illusory Third Party Buying Experience

(71) Applicant: DELL PRODUCTS, LP, Round Rock, TX (US)

(72) Inventors: Subramanian Rama, Austin, TX (US); Guru Abhishek Shastry, Round Rock, TX (US); Peter T. Whitesell, Austin, TX (US); Ezra J. Chu, Austin, TX (US); Cristian A. Dumitru, Austin, TX (US); Jeremy Patton, Pflugerville, TX (US)

(21) Appl. No.: 15/054,939

(22) Filed: Feb. 26, 2016

(51) Int. Cl. G06Q 30/06; H04L 29/08; H04L 29/06

(52) U.S. Cl. CPC G06Q 30/0613; G06Q 30/0633; H04L 67/42; H04L 67/02

(57) ABSTRACT

A third party e-commerce transaction is performed as an inline frame within a webpage. A user of the webpage may thus purchase a product or service from a trusted hosting entity, even though a different third party vendor processes the user's payment information and ships the product (and/or provides the service). Webpages may thus offer more third party products and services without incurring warehousing and payment processing burdens. The purchase transaction occurs entirely within the hosting entity's webpage, perhaps even without revealing the third party vendor.

### FIELD OF THE DISCLOSURE

The present disclosure generally relates to information handling systems, and more particularly relates to third party purchase transactions.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIGS. 2-5 illustrate a system for creating an illusory third party buying experience, according to exemplary embodiments;

FIGS. 6-7 illustrate a system for creating an affiliate relationship, according to exemplary embodiments;

FIG. 8 illustrates pre-population of data fields, according to exemplary embodiments;

FIG. 9 illustrates a system for creating a branded third party buying experience, according to exemplary embodiments;

FIG. 10 illustrates details of a third-party “Buy” button, according to exemplary embodiments; and

FIG. 11 is a flowchart illustrating a method or algorithm for the third party buying experience, according to exemplary embodiments.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

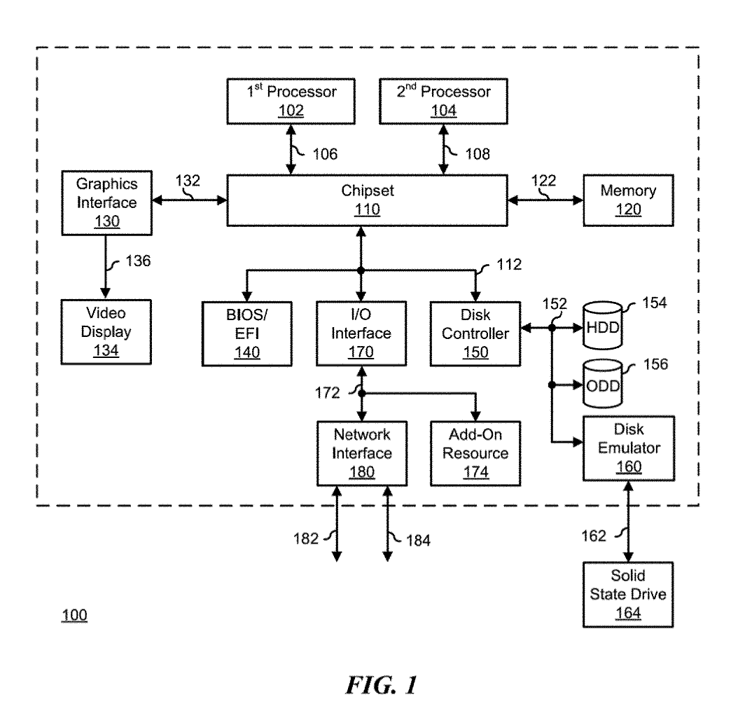

FIG. 1 illustrates a generalized embodiment of information handling system 100, according to exemplary embodiments. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processors 102 and 104, a chipset 110, a memory 120, a graphics interface 130, include a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/0 channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disc controller 150 to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

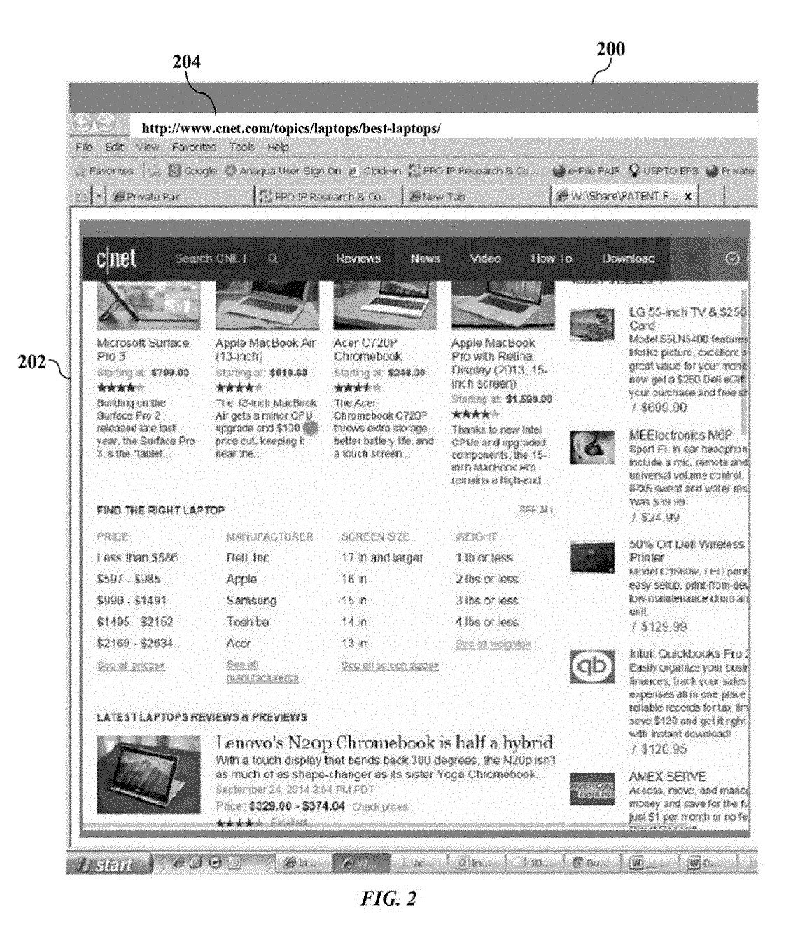

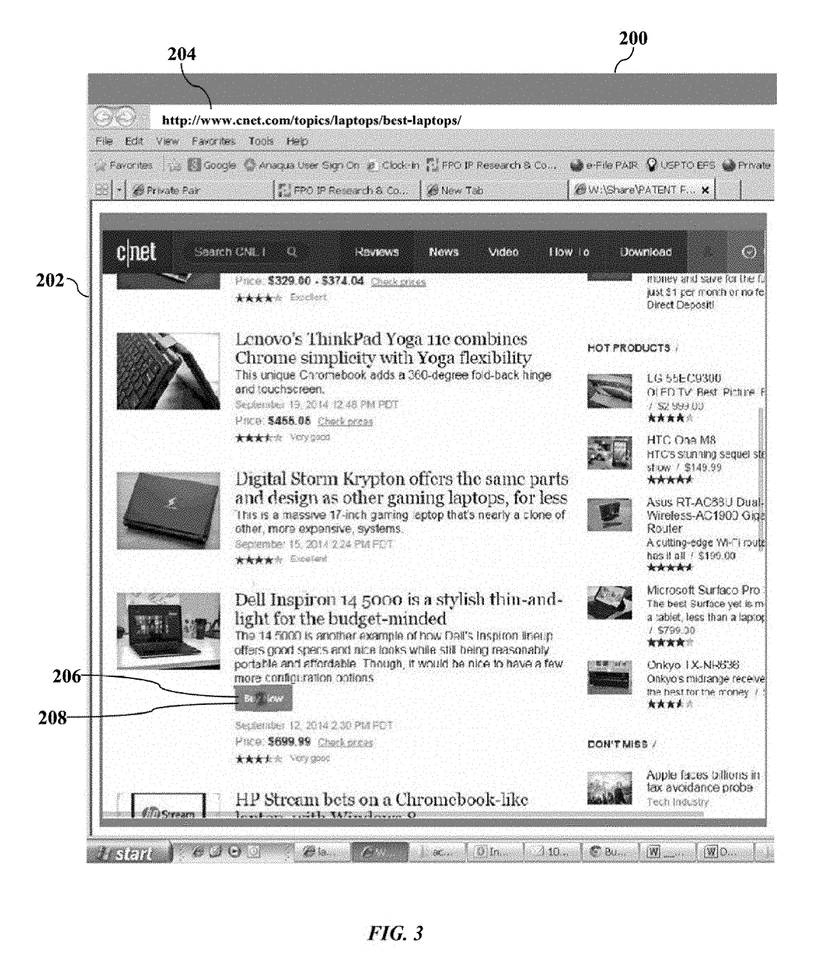

FIGS. 2-5 illustrate a system 200 for creating an illusory third party buying experience, according to exemplary embodiments. FIG. 2 is a screenshot of a conventional web-based e-commerce marketplace 202. A hosted webpage 204 (such as www.cnet.com/reviews) offers reviews and pricing for different goods and services. A user may thus peruse the offerings and select a product or service of interest. FIG. 3, though, illustrates a selectable option 206 for purchasing one of the different goods or services. FIG. 3, for example, illustrates the selectable option 206 as a third-party “Buy” button 208. An operator or provider adds the third-party “Buy” button 208 to the webpage 204 as a nearly immediate purchasing mechanism. If the user wishes to purchase the corresponding product or service, the user touches or otherwise tactilely selects the third-party “Buy” button 208.

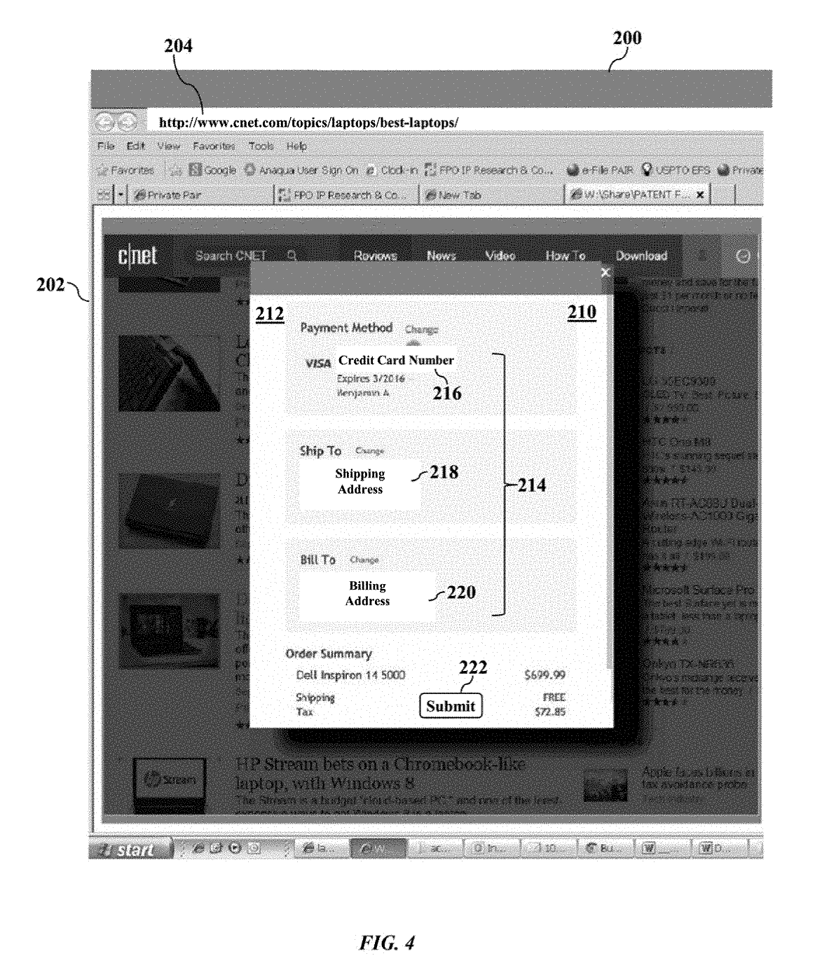

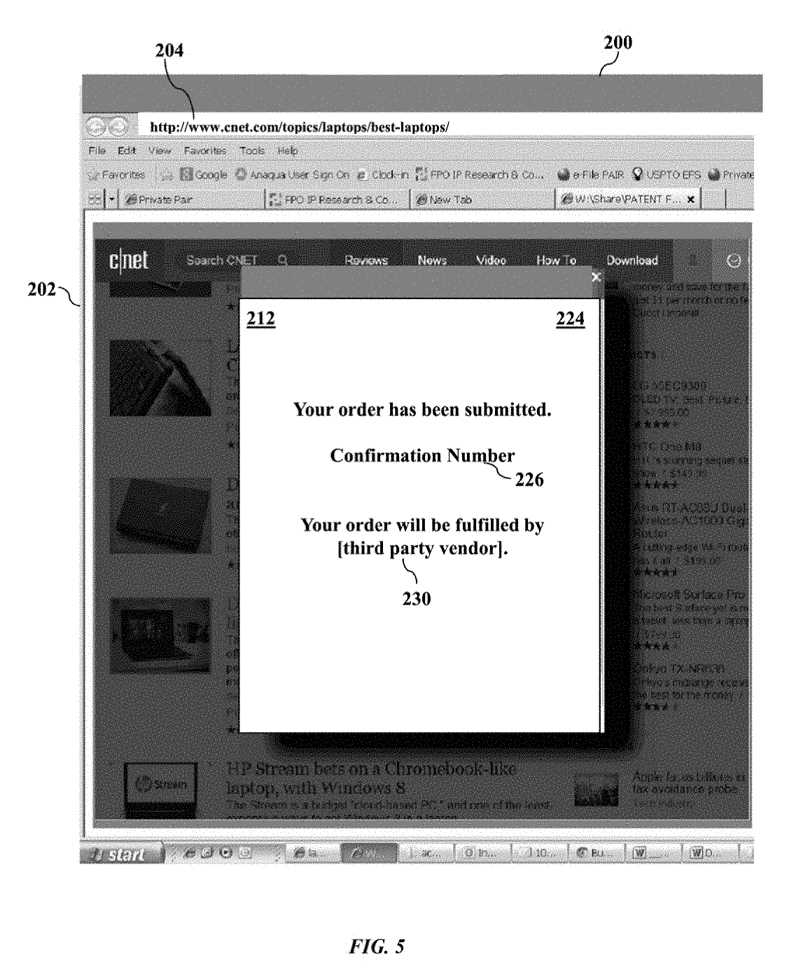

FIGS. 4-5 illustrate the third party buying experience 200. When the user wishes to purchase the offered good or service (using the third-party “Buy” button 208 illustrated in FIG. 3), the user is presented with the third party buying experience 200. That is, an integrated commerce modal 210 overlays the webpage 204 for conducting an electronic financial transaction 212. The integrated commerce modal 210 displays, appears, or pops up to buy the good or service that corresponds with the third-party “Buy” button 208 (as illustrated in FIG. 3). FIG. 4 emphasizes the integrated commerce modal 210 by nearly opaquing display of the webpage 204, which is merely an optional feature. Regardless, the user may enter her transaction details 214 (such as a credit card number 216, shipping address 218, and billing address 220) and perhaps select a “Submit” control button 222. FIG. 5 thus illustrates a confirmation 224 that may also overlay the webpage 204 (again perhaps darkened or opaqued for emphasis). The confirmation 224 confirms the electronic financial transaction 212 (perhaps providing a confirmation number 226). Once the electronic financial transaction 212 is confirmed, the graphical integrated commerce modal 210 may then disappear to again reveal the hosted webpage 204 (e.g., www.cnet.com/reviews). Exemplary embodiments thus allow the user to quickly check out without leaving the webpage 204 or without being redirected to a different webpage.

Exemplary embodiments may thus provide the illusory third party buying experience 200. Even though the user's client device (such as the information handling system 100 illustrated in FIG. 1) downloads the webpage 204, exemplary embodiments may conduct the electronic financial transaction 212 with a different third party 230. That is, the third party may own the electronic financial transaction 212 with the user, even though the electronic financial transaction 212 occurs within the hosted webpage 204 (and thus outside the third party's hosted environment). The reader may thus notice that the user's client device downloaded the webpage 204 hosted on behalf of cNET® at www.cnet.com/reviews. The electronic financial transaction 212, though, was conducted with the different third party 230 as a vendor or supplier of the purchased product. The user's client device did not redirect or download a different webpage. Exemplary embodiments thus provide an appearance of continuity and allegiance with the hosted webpage 204, even the electronic financial transaction 212 is conducted with the third party 230. The user's checkout buying experience thus remains constant and may or may not reveal the third party's identity (as later paragraphs will explain).

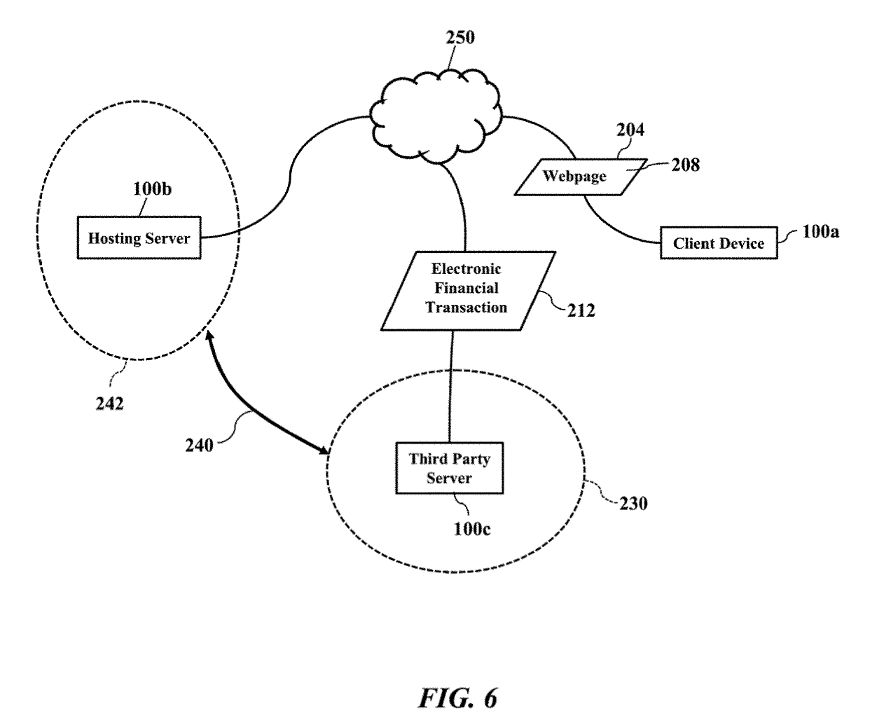

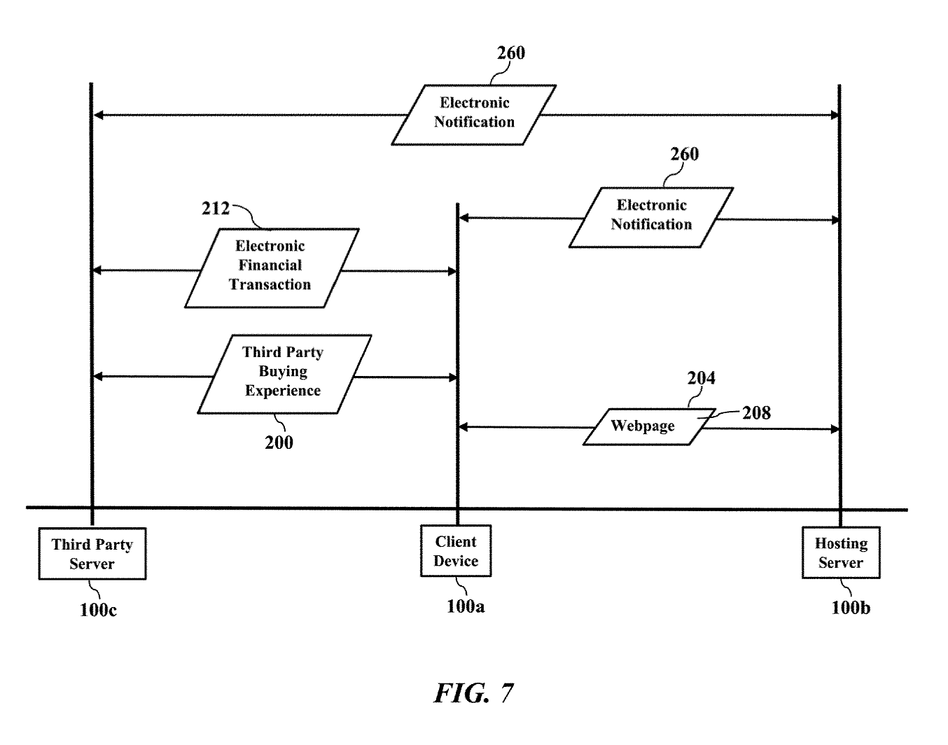

FIGS. 6-7 illustrate an affiliate relationship 240, according to exemplary embodiments. The third party 230 may affiliate itself with a hosting entity 242 associated with the webpage 204. The hosting entity 242, in other words, may offer the third party's goods and services on the webpage 204. The hosting entity 242 adds the third-party “Buy” button 208 as programming code to the webpage 204. When the user's client device (such as the information handling system 100a) requests the webpage 204 from a hosting server (such as a different information handling system 100b associated with the hosting entity 242), the user's client device 100a also loads the programming code representing the third-party “Buy” button 208. Should the user's client device 100a receive a selection of the third-party “Buy” button 208, the electronic financial transaction 212 is conducted with the third party 230. The user's client device 100a thus communicates with the hosting server 100b and with a third party server (the information handling system 100c) associated with the third party 230 via a communications network 250 to send and receive electronic data. The electronic data is packetized into packets of data according to a packet protocol (such as any of the Internet Protocols). The packets of data contain bits or bytes of data describing the contents, or payload, of a message. A header of each packet of data may contain routing information identifying an origination address and/or a destination address.

As FIG. 7 illustrates, one or more electronic notifications 260 may be sent. For example, the third party server 100c may notify the hosting server 100b of the details associated with the electronic financial transaction 212 conducted with the user's client device 100a. The electronic notification 260 may thus include data and/or information describing the purchased good or service, purchase price, buyer/shipping information, third party vendor, payment information, and any other details. The user's client device 100a may additionally or alternatively send the electronic notification 260 detailing the electronic financial transaction 212. The third party's goods and services thus appear as an affiliate play on the hosting entity's webpage 204, even though the third party 230 controls the electronic financial transaction 212.

Exemplary embodiments thus present an elegant multi-party solution. The user, as a first party, downloads the webpage 204 associated with the hosting entity 242 as a second party. When the user's client device 100a invokes the third-party “Buy” button 208, though, the integrated commerce modal 210 may be securely delivered inside the webpage 204. The user and the third party 230 thus securely transact without changing a uniform resource locator (URL) representing the webpage 204. Exemplary embodiments may thus provide an illusory buying experience that does not reveal the third party's identity.

Exemplary embodiments may thus shift the e-commerce experience. Many people are leery of buying from unknown or obscure websites. Exemplary embodiments thus allow the hosting entity 242 to act as a “middleman” to the third party's goods and services. For example, Amazon®, Google®, facebook®, and other well-known aggregators may offer many products and services from third party affiliates. Buyers may thus feel very comfortable conducting business with any well-known hosting entity 242, even though the actual electronic financial transaction 212 is conducted with the different third party 230. The hosting entity 242 may thus offer tremendously more products and services without the corresponding warehousing needs and backend processing. Moreover, the hosting entity 242 has tremendous leverage to ensure the third party 230 abides by policies and procedures or risks delisting from the webpage 204.

Exemplary embodiments may also permit single purchase experiences. Because there may be many different third parties 230 listing their products and services on the hosting entity's webpage 204, exemplary embodiments may permit quick single purchases with an individual third party. The user, in other words, may merely touch or click the third-party “Buy” button 208 to buy the corresponding good or service. Each single purchase may thus be advantageously processed and shipped by the corresponding third party. Again, then, the hosting entity 242 is relieved of the burdensome processing associated with multiple items from multiple different vendors in a conventional electronic shopping cart.

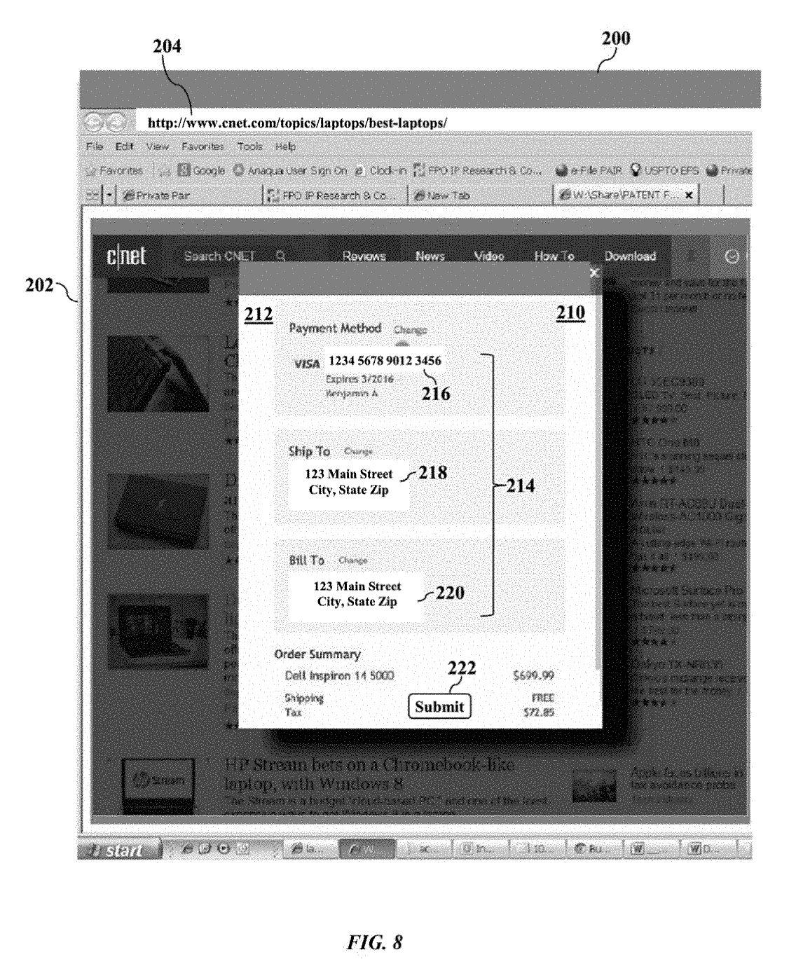

FIG. 8 illustrates pre-population of data fields, according to exemplary embodiments. As the reader may understand, many websites store a user profile that corresponds to each user. The user may thus login with her credentials (e.g., username and password) and receive some personalized service and offering. For example, the integrated commerce modal 210 may be pre-populated with information from the user's profile, such as her credit card number 216, shipping address 218, and billing address 220. So, after selecting the third party “Buy” button 208 (illustrated in FIG. 3), exemplary embodiments may retrieve profile information to further ensure conversion to purchase. The user may thus merely select the “Submit” control button 222 as confirmation of her purchase decision. Indeed, exemplary embodiments may merely confirm after selection of the third party “Buy” button 208, thus providing a truly one click purchasing experience. The transaction details 214 may thus be stored by the user's client device 100a, the hosting entity 242, and/or the third party 230. The user may thus select the third-party “Buy” button 208 and confirm her purchase to provide an even quicker and simpler checkout experience.

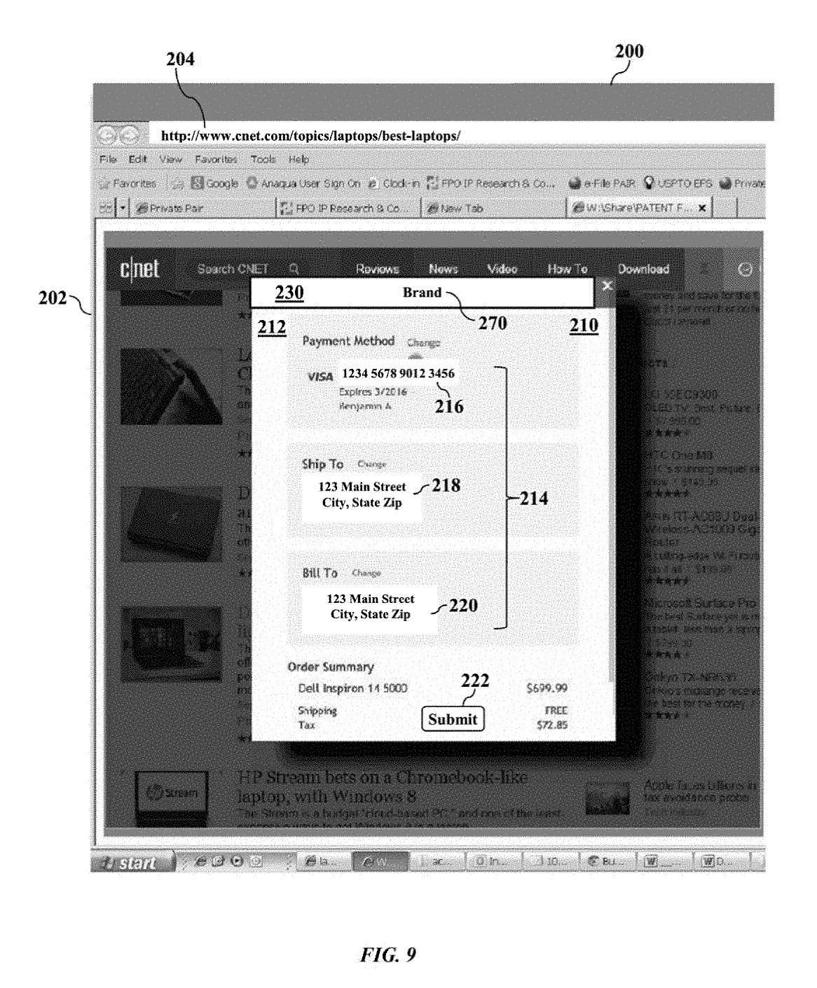

FIG. 9 illustrates a branded third party buying experience 200, according to exemplary embodiments. Here the integrated commerce modal 210 may overtly identify the third party 230. That is, when the user selects the third-party “Buy” button 208 (illustrated in FIG. 3), the integrated commerce modal 210 may explicitly identify the third party 230 selling the good or service. FIG. 9 thus illustrates a brand 270 added to the integrated commerce modal 210. The brand 270 may be a logo, phrase, name, or other identifier associated with the third party 230. So, even though the integrated commerce modal 210 overlays the hosting entity's webpage 204, exemplary embodiments may alert the user to the electronic financial transaction 212 conducted with the different third party 230. The user may thus plainly see that she is buying from the third party 230, even though her web browser did not leave the URL associated with the hosting entity's webpage 204. Once the electronic financial transaction 212 is confirmed (such as the confirmation 224 illustrated in FIG. 5), the integrated commerce modal 210 disappears to again completely reveal the hosted webpage 204 (e.g., www.cnet.com/reviews).

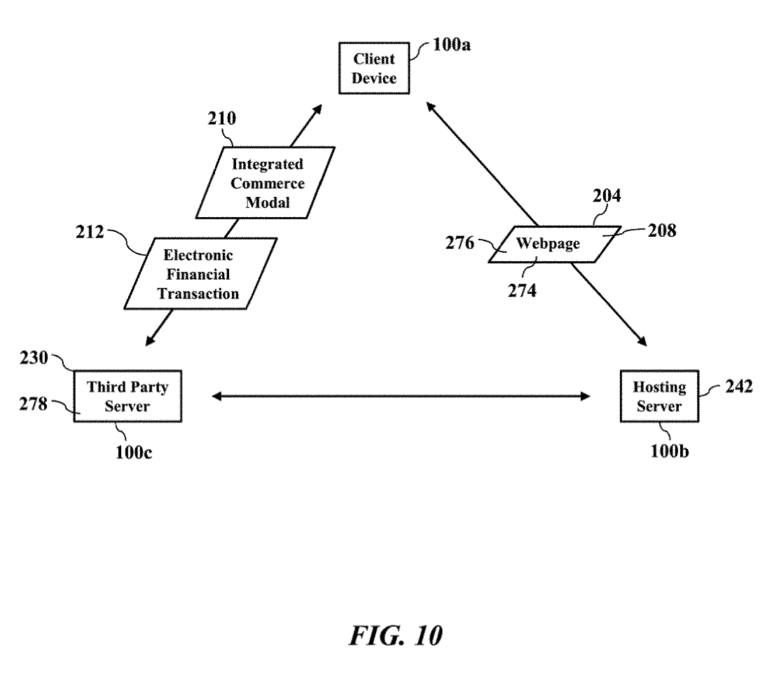

FIG. 10 illustrates more details of the third-party “Buy” button 208, according to exemplary embodiments. As this disclosure earlier explained, the third-party “Buy” button 208 may be added as programming code to the webpage 204. The hosting entity 242, for example, merely adds a single line of JAVASCRIPT® 274 and an identifier 276 of the corresponding good or service. For example, the programming code may be
<script src=“http://dell.com/buyButton.js”></script>
   that identifies a third party website 278 (dell.com/buyButton.js) hosted by or on behalf of the third party 230. The hosting entity 242 may then instrument the third-party “Buy” button 208 (if it so chooses) by adding any HTML element setting “data-buybutton” data attribute such as:
<button data-buybutton=“55d1dce77645a8c5e03b5-f2b55d1dce77645a8c5e03b5f2c”>Buy</button>.
   When the user's client device 100a downloads the webpage 204 from the hosting server 100b (associated with the hosting entity 242), the user's device 100a also loads the programming code representing the third-party “Buy” button 208. The integrated commerce modal 210 may thus be a pixel fire buyer device that links or interfaces with the third party server 100c. When the user selects the third-party “Buy” button 208, exemplary embodiments open the Javascript® 274 as an inline frame HTML document that is embedded inside the webpage 204. The third-party “Buy” button 208 is thus securely delivered from the third party server 100c as an inside component of the webpage 204, even though the electronic financial transaction 212 is securely conducted outside the webpage 204.

Exemplary embodiments thus present an elegant out of application solution. The third-party “Buy” button 208 is retrieved from, powered by, and maintained by the third party 230. The e-commerce experience, though, appears within the hosting entity' software application (such as the webpage 204). The third-party “Buy” button 208 thus provides an illusion that the customer/user never leaves the hosting entity's webpage 204. The user's client device 100a presents no indication or experience of navigating to a URL associated with the third party 230. The electronic financial transaction 212 is quickly conducted and the integrated commerce modal 210 shuts down and closes.

Exemplary embodiments may be applied to any webpage. The programming code representing the third-party “Buy” button 208 may be added to the webpage 204 associated with any hosting entity 242. The third-party “Buy” button 208 may thus be integrated into or with any software platform or application to easily add e-commerce capabilities.

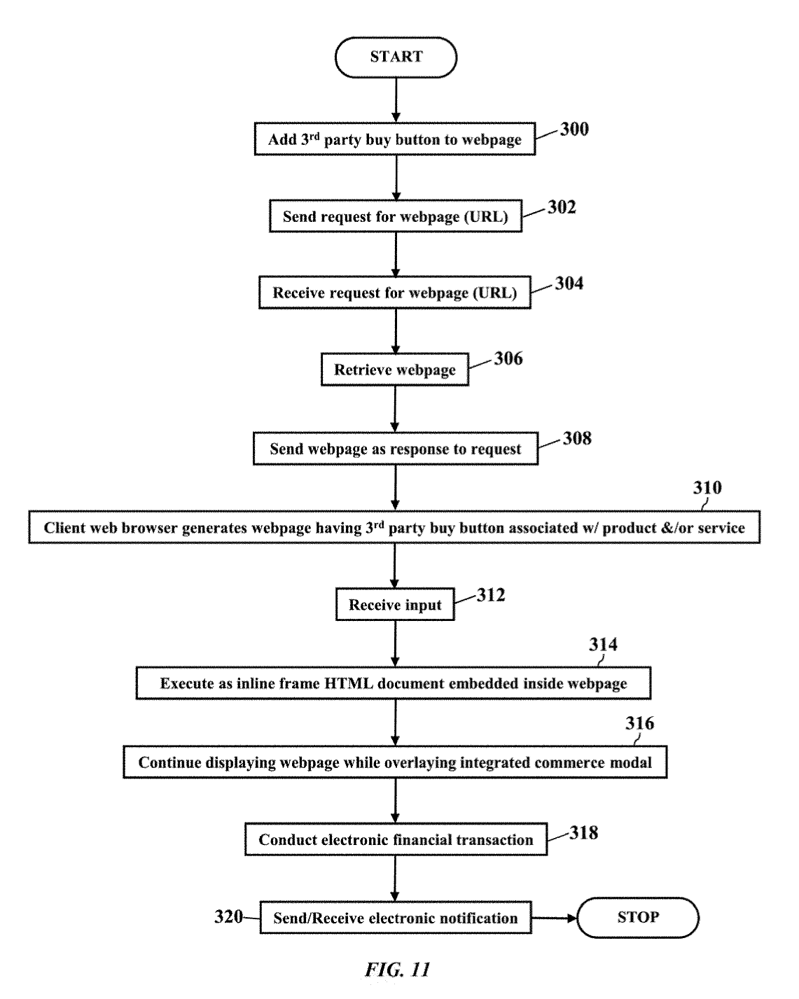

FIG. 11 is a flowchart illustrating a method or algorithm for the third party buying experience 200, according to exemplary embodiments. The third-party “Buy” button 208 is added to the webpage 204 (Block 300). The user's client device 100a executes a web browser and sends an electronic request for the URL associated with the webpage 204 (Block 302). The electronic request is addressed to a network address associated with the hosting server 100b and sent into the communications network 250. The hosting server 100b receives the electronic request (Block 304) and retrieves the webpage 204 that corresponds to the URL having the programming code representing the third-party “Buy” button 208 inserted therein (Block 306). The hosting server 100b sends the webpage 204 as a response to the network address associated with the user's client device 100a (Block 308). The web browser generates the webpage 204 for display having the third-party “Buy” button 208 associated with a product or service (Block 310). An input is received that selects the third-party “Buy” button 208 (Block 312). The user's client device 100a opens and executes the Javascript® 274 as an inline frame HTML document that is embedded inside the webpage 204 (Block 316). The user's client device 100a continues displaying the hosting entity's webpage 204, even though the web browser overlays the integrated commerce modal 210 (Block 318) and conducts the electronic financial transaction 212 with the network address associated with the website associated with the third party server 100c (Block 320). The electronic notification 260 may be sent/received that confirms the electronic financial transaction 212 conducted the inline frame within the webpage 204 (Block 322).

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/0) devices, such as a keyboard, a mouse, a video/graphic display, or any combination thereof. The information handling system can also include one or more buses operable to transmit communications between the various hardware components. Portions of an information handling system may themselves be considered information handling systems.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method, comprising:
receiving, by a server, a request for a webpage associated with a hosting entity, the request for the webpage sent from a client device;
retrieving, by the server, the webpage having inserted therein a selectable option for conducting an electronic financial transaction as an inline frame within the webpage, the electronic financial transaction conducted between the client device and a website associated with a third party;
sending, by the server, the webpage to a network address associated with the client device; and
receiving, by the server, an electronic notification confirming the electronic financial transaction conducted as the inline frame within the webpage between the client device and the website associated with the third party.

2. The method of claim 1, further comprising specifying the website associated with the third party within the webpage.

3. The method of claim 1, further comprising receiving the electronic notification sent from an address associated with the third party, the electronic notification confirming the electronic financial transaction conducted with the client device.

4. The method of claim 1, further comprising receiving the electronic notification sent from the network address associated with the client device, the electronic notification confirming the electronic financial transaction conducted with the third party.

5. The method of claim 1, further comprising adding a product identifier to the website, the product identifier identifying a product associated with the selectable option.

6. The method of claim 1, further comprising branding the electronic financial transaction conducted as the inline frame within the webpage between the client device and the website associated with the third party.

7. An information handling system, comprising:
a processor; and
a memory accessible to the processor, the memory storing instructions that when executed cause the processor to perform operations, the operations comprising:
receiving a request for a webpage associated with a hosting entity, the request for the webpage sent from a client device;
retrieving the webpage having inserted therein a selectable option for conducting an electronic financial transaction as an inline frame within the webpage between the client device and a website associated with a third party;
sending the webpage to a network address associated with the client device; and
receiving an electronic notification confirming the electronic financial transaction conducted as the inline frame within the webpage between the client device and the website associated with the third party.

8. The system of claim 7, wherein the operations further comprise specifying the website associated with the third party within the webpage.

9. The system of claim 7, wherein the operations further comprise receiving the electronic notification sent from an address associated with the third party, the electronic notification confirming the electronic financial transaction conducted with the client device.

10. The system of claim 7, wherein the operations further comprise receiving the electronic notification sent from the network address associated with the client device, the electronic notification confirming the electronic financial transaction conducted with the third party.

11. The system of claim 7, wherein the operations further comprise adding a product identifier to the website, the product identifier identifying a product associated with the selectable option.

12. A memory device storing instructions that when executed cause a processor to perform operations, the operations comprising:
sending a request for a webpage hosted on behalf of a hosting entity, the request for the webpage sent from a client device;
receiving the webpage from the hosting entity, the webpage having inserted therein a selectable option for conducting an electronic financial transaction as an inline frame within the webpage between the client device and a website associated with a third party;
receiving an input that selects selectable option; and
generating an integrated commerce modal in response to the input, the integrated commerce modal generated as the inline frame within the webpage, the integrated commerce modal conducting the electronic financial transaction between the client device and the website associated with the third party.

13. The memory device of claim 12, wherein the operations further comprise overlaying the integrated commerce modal onto the webpage received from the hosting entity.

14. The memory device of claim 12, wherein the operations further comprise constantly displaying the webpage received from the hosting entity while the electronic financial transaction is conducted between the client device and the website associated with the third party.

15. The memory device of claim 12, wherein the operations further comprise branding the integrated commerce modal.

16. The memory device of claim 12, wherein the operations further comprise sending an electronic notification confirming the electronic financial transaction conducted as the inline frame within the webpage between the client device and the website associated with the third party.
